(19) United States
(12) Patent Application Publication
(10) Pub. No.: US 2006/0175867 A1
(43) Pub. Date: Aug. 10, 2006

(54) Door, in particular for a motor vehicle

(76) Inventors: Gerd Heuel, Olpe (DE); Ralf Rottmann, Drolhagen (DE); Dirk Rau, Finnentrop (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/347,006

(22) Filed: Feb. 3, 2006

(30) Foreign Application Priority Data
Feb. 4, 2005 (DE) 10 2005 005 329.7
Mar. 7, 2005 (DE) 10 2005 010 395.2
Oct. 12, 2005 (DE) 10 2005 048 786.6

(51) Int. Cl. B60J 5/06

(52) U.S. Cl. 296/155

(57) ABSTRACT

A door for a vehicle comprises a pivot joint at which a support arm is pivotably supported. The support arm is hingedly connectable to the vehicle. So that the door can be opened both by a pivoting movement and by a sliding movement, the pivot joint can be locked.

### CROSS REFERENCE TO RELATED APPLICATION

This application claims priority to German Patent Application Serial No. 10 2005 005 329.7 filed Feb. 4, 2005, German Patent Application Serial No. 10 2005 010 395.2 filed Mar. 7, 2005, and German Patent Application Serial No. 10 2005 048 786.6 filed Oct. 12, 2005, all of which are hereby incorporated by reference in their entirety for all purposes.

### FIELD

The present disclosure relates to a door for a vehicle, in particular for a motor vehicle. The present disclosure furthermore relates to a vehicle, in particular to a motor vehicle. The present disclosure can be used in vehicles of all kinds, that is, in land vehicles, water vehicles and air vehicles.

### BACKGROUND AND SUMMARY

A door for a motor vehicle, comprising a pivot joint at which an articulated arm hingedly connectable or connected to the vehicle is pivotably supported, is known from DE 30 26 037. It is a so-called sliding door. To open the door, it must first be pivoted out of the plane of the vehicle body. The door is subsequently displaced to the front or to the rear parallel to the vehicle body. The door accordingly includes a pivot joint to which an articulated arm is pivotably supported. The other end of the articulated arm is hingedly connected to the motor vehicle.

It is an object of the present disclosure to provide a door for a vehicle which can be opened and closed both as a sliding door and as a pivoting door.

This object is solved in accordance with the present disclosure by a door for a vehicle, in particular for a motor vehicle, comprising a pivot joint at which an articulated arm hingedly connectable or connected to the vehicle is pivotably supported, wherein the pivot joint at which the pivot arm is pivotably supported is lockable. When the door is to be opened as a pivoting door, the pivot joint is locked. The door can then be opened by turning the hinged connection of the articulated arm to the vehicle. When the door is to be opened as a sliding door, the lock of the pivot joint is released. On the opening of the door, the articulated arm is pivoted about the joint provided at the vehicle. The pivot joint is also pivoted—in the opposite direction—in this process so that the door is pivoted out of the plane of the body. It can then be displaced parallel to the vehicle body.

Advantageous further developments are also possible.

The pivot joint can preferably be locked in a plurality of pivot positions. It is advantageous for the pivot joint to be able to be locked in two pivot positions. The first pivot position is preferably that pivot position in which the pivot joint is located when the door is closed. When the pivot joint is locked in this pivot position, the door can be opened by a pivot movement, that is, as a pivot door. The second pivot position, in which the pivot joint can be locked, is preferably that pivot position in which the pivot joint is located when the articulated arm and the door have been pivoted such that the door is located at a spacing from the body of the vehicle and is located in a direction parallel to the body of the vehicle. In this locked pivot position, the door can then be displaced parallel to the vehicle body, that is, the door can be opened as a sliding door.

It is advantageous for the pivot range of the pivot joint to be limited.

A further advantageous further development is that the pivot joint is provided at a guide carriage which is displaceably guided in a guide rail. The guide rail is provided in the door.

In accordance with another advantageous further development, a tie rod is provided which is connected to the guide carriage. The tie rod is preferably hingedly connected to the guide carriage. The pivot axle of the tie rod at the guide carriage is preferably located at a spacing from the pivot joint of the articulated arm at the guide carriage.

Another advantageous further development is that the tie rod can be or is selectively connected to the articulated arm or hingedly to the vehicle. The joint axle between the tie rod and the vehicle is preferably located at the vehicle at the spacing of the pivot axle of the articulated arm.

In accordance with another advantageous further development, a first index bolt is present which can be brought into a position connecting the tie rod to the articulated arm. It is advantageous if a second index bolt is instead or additionally present which can be brought into a position hingedly connecting the tie rod to the vehicle. It is possible to provide a plurality of first index bolts and/or a plurality of second index bolts. It is advantageous if two first index bolts and/or two second index bolts are present. One or both index bolts can be spring-loaded. The first index bolt and/or the second index bolt can be brought into the described index position by a slide curve.

In accordance with another advantageous further development, a rotary slide is present by which the first index bolt can be brought into the position connecting the tie rod to the articulated arm. Instead or additionally, the second index bolt can be brought into the position hingedly connecting the tie rod to the vehicle by the rotary slide. The rotary slide is preferably provided at the vehicle at the pivot axle of the articulated arm.

It is advantageous for a lock lever to be pivotably supported at the guide carriage.

Another advantageous further development is that the lock lever has a guide groove for a lock bolt provided at the door. The guide groove is substantially directed toward the pivot axis of the lock lever.

In one example, a vehicle, in particular a motor vehicle, may include one or more doors in accordance with the present disclosure.

### BRIEF DESCRIPTION OF THE FIGURES

Embodiments of the present disclosure will be explained in detail in the following with reference to the enclosed drawing. There are shown in the drawings:

FIG. 1 is a door for a motor vehicle in the closed state in a sectional view from above;

FIG. 2 is the door of FIG. 1 after a pivoting out of the plane of the body;

FIG. 3 is the door of FIGS. 1 and 2 in the partly displaced state;

FIG. 4 is the door of FIGS. 1 to 3 in the state opened by a pivot movement;

FIG. 5 is another embodiment of a door for a motor vehicle in the closed state in a sectional view from above;

FIG. 6 is the door of FIG. 5 after a pivoting out of the plane of the body;

FIG. 7 is an enlarged partial view of FIG. 6;

FIG. 8 is the door of FIGS. 5 to 7 in the fully displaced state;

FIG. 9 is the door of FIGS. 5 to 8 in the state opened by a pivot movement;

FIG. 10 is an enlarged part view of FIG. 9;

FIG. 11 is a section along the line A-A in FIG. 7; and

FIG. 12 is a section along the line B-B in FIG. 7.

### DETAILED DESCRIPTION

The Figures of the drawing show a door 1 connected to a motor vehicle 2. The door 1 comprises a door box 3 and an outer panel 4. In the interior region of the door box 3 facing the vehicle 2, a pivot joint 5 is secured in which the swivel pin 6 of an articulated arm 7 is pivotably supported. The articulated arm 7 comprises a straight middle piece from which two respective end pieces angle off at an angle of approximately 45°.

The articulated arm 7 is provided at its other end with a further swivel pin 8 which is hingedly supported in a hinge 9. The hinge 9 is connected to the body of the motor vehicle. It is fastened to a panel 11 of the A pillar 10. A seal 12 is fastened to the peripheral flange of the door section.

The pivot joint 5 is provided at a guide carriage 13 which is displaceably guided in a guide rail 14 of the door 1. The guide rail 14 extends in the direction of the body, that is, in the longitudinal direction of the vehicle.

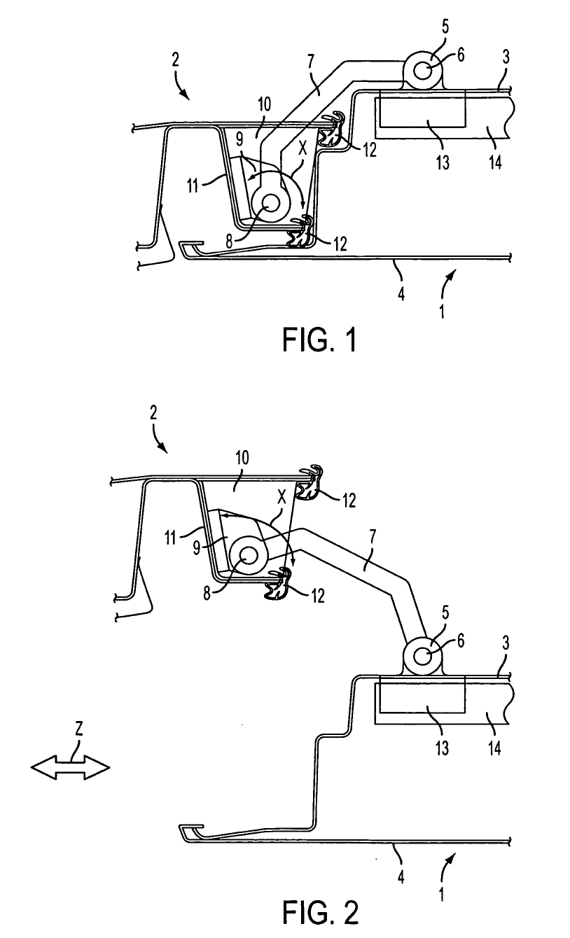

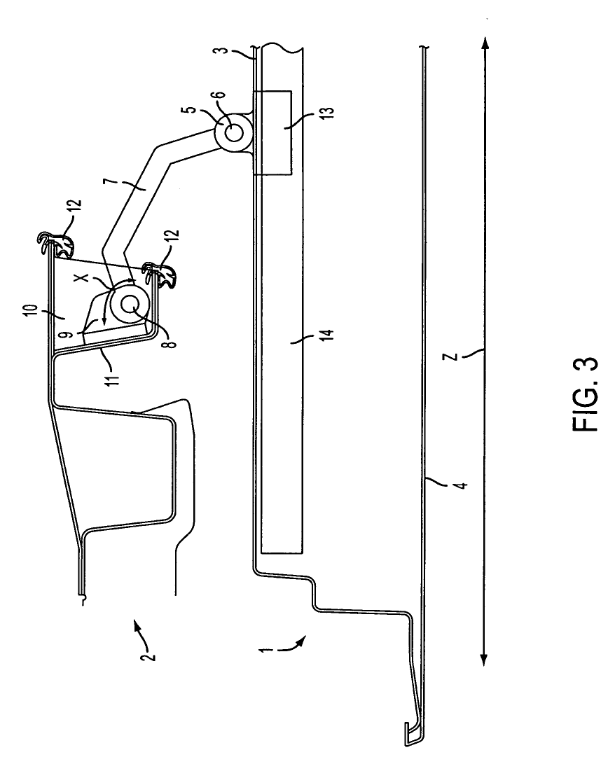

The pivot joint 5 can be locked. It can be locked both in the position shown in FIG. 1 and in the position shown in FIGS. 2 and 3.

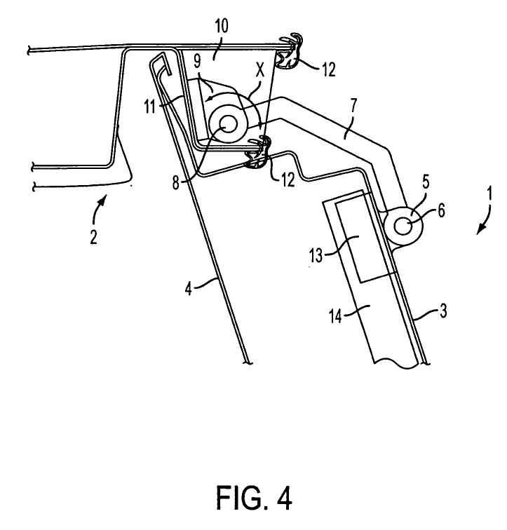

When the door 1 should be opened by a pivot movement out of the closed position shown in FIG. 1, the pivot joint 5 is locked in the position shown in FIG. 1. Furthermore, the guide carriage 13 is locked in the position shown in FIG. 1. The door 1 still closed in FIG. 1 is opened like a conventional pivot door with a pivot movement around the hinge 9 until the open position shown in FIG. 4 is reached.

When the door should be opened by a sliding movement, the locks of the pivot joint 5 and of the guide carriage 13 are released. The door 1 is subsequently pivoted into the position shown in FIG. 2. The articulated arm 7 pivots around the hinge 9 in a clockwise direction. The door 1 carries out a counterclockwise pivot movement relative to the articulated arm 7 in the pivot joint 5. During these pivot movements, the guide carriage 13 moves a certain distance to the rear in the guide rail 14 and then back into the position shown in FIG. 2. This distance can be limited by an abutment in the guide rail 14 (not shown in the drawing).

When the position shown in FIG. 2 is reached in which the door 1 is located at a distance from the body of the vehicle and in which the door 1 is furthermore located in a direction parallel to the vehicle body, the pivot joint 5 is locked. Furthermore, the locking of the guide carriage 13 remains in the position of FIG. 2 or is released. The door 1 can then be displaced in the z direction, that is, in the direction parallel to the vehicle body or in the longitudinal direction of the vehicle. A corresponding position of the door 1, in which the door 1 is partly opened, is shown in FIG. 3.

The pivot range of the pivot joint 5 is restricted in the manner such that the door 1 cannot be pivoted clockwise beyond the position in FIG. 1 with respect to the articulated arm 7 and also not beyond the position shown in FIG. 2 with respect to the articulated arm 7 in a counterclockwise direction.

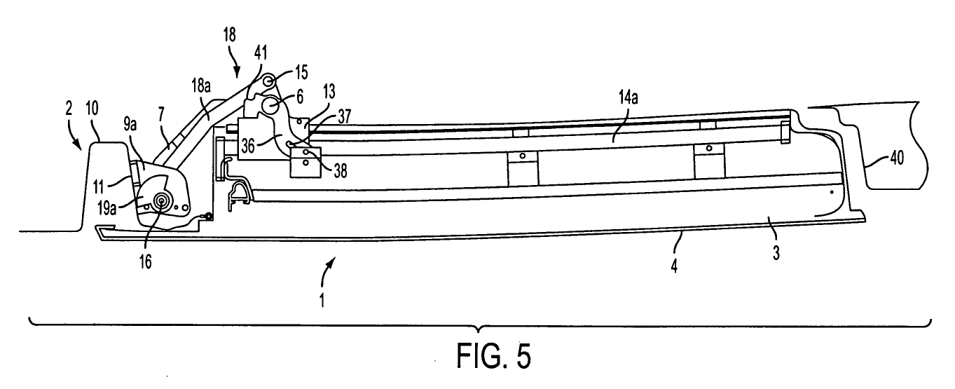

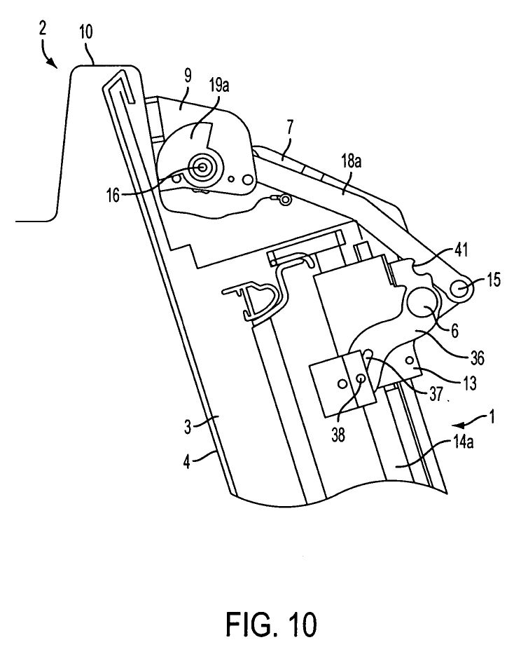

FIGS. 5 to 12 show a modified embodiment in which corresponding components are provided with the same reference numerals. In addition to the articulated arm 7, a tie rod 18 is present which is connected to the vehicle and to the guide carriage.

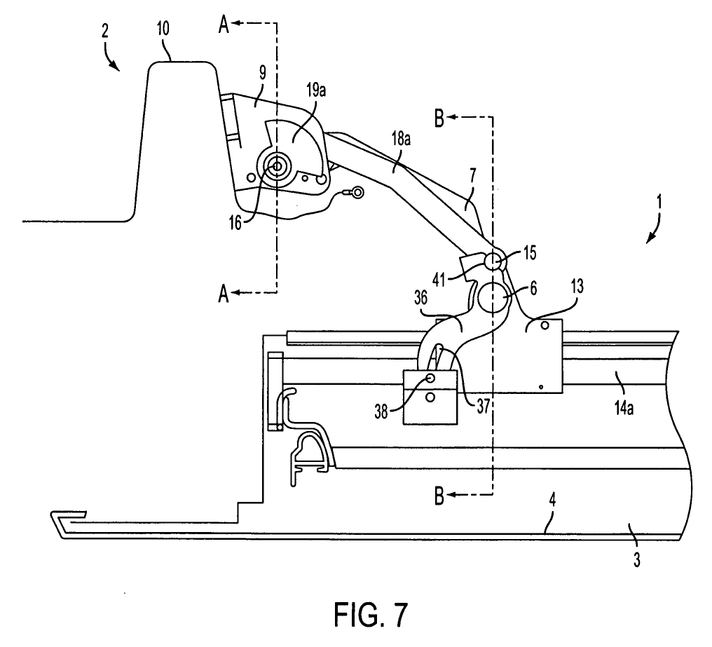

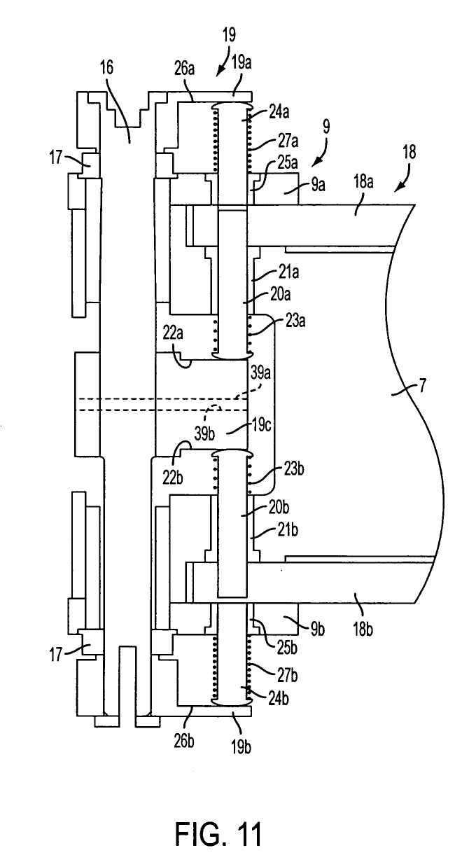

FIG. 11 shows a section along the line A-A in FIG. 7 through the support shaft 16 which is rotatably supported by grooved ball bearings 17 at the hinge 9 connected to the body of the motor vehicle. The articulated arm 7 is pivotably supported at the support shaft 16. A tie rod 18 is furthermore present which includes an upper tie rod 18a and a lower tie rod 18b. The upper tie rod 18a is located between the articulated arm 7 and the upper part 9a of the hinge 9. The lower tie rod 18b is disposed between the articulated arm 7 and the lower part 9b of the hinge 9. The tie rods 18a, 18b are slidingly jammed in this manner between the articulated arm 7 and the parts 9a and 9b of the hinge 9.

A rotary slide 19 is rotationally fixedly connected to the support shaft 16 and has an upper part 19a, a lower part 19b and a middle part 19c. First index bolts 20a, 20b which are longitudinally displaceably guided in associated bearing bushings 21a, 21b are present in the articulated arm 7. The bearing bushings 21a, 21b extend parallel to and spaced from the bearing shaft 16. The head at the lower end of the upper first index bolt 20a lies on the upper slide curve of the middle part 19c of the rotary slide 19. In a corresponding manner, the head at the upper end of the lower first index bolt 20b lies on the lower slide curve 22b of the middle part 19c of the rotary slide 19. The first index bolts 20a, 20b are loaded toward the slide curves 22a, 22b by compression springs 23a, 23b which are provided between the bearing bushings 21a, 21b and the heads of the first index bolts 20a, 20b.

In a corresponding manner, second index bolts 24a, 24b are present in the hinges 9a, 9b and are guided longitudinally displaceably in associated bearing bushings 25a, 25b. The bearing bushings 25a, 25b extend parallel to and spaced from the bearing shaft 16. The head at the upper end of the upper second index bolt 24a lies on the slide curve 26a at the lower side of the upper part 19a of the rotary slide 19. In a corresponding manner, the head at the lower end of the lower second index bolt 24b lies on the slide curve 26b at the upper side of the lower part 19b of the rotary slide 19. The second index bolts 24a, 24b coincide with the first index bolts 20a, 20b. The second index bolts 24a, 24b are loaded toward the slide curves 26a, 26b by compression springs 27a, 27b which are provided between the bearing bushings 25a, 25b and the heads of the second index bolts 24a, 24b.

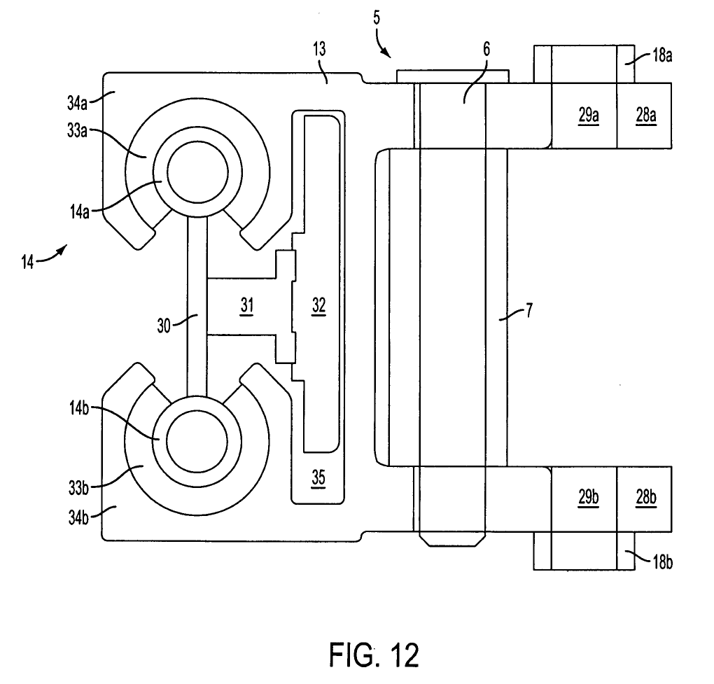

As can be seen from FIG. 12, a pivot joint 5 is provided at the guide carriage 13 and a vertical swivel pin 6 is rotatably supported in it. The support positions are located in an upper support plate 28a and a lower support plate 28b which extend parallel to one another and spaced from one another and between which the articulated arm 7 is arranged which is likewise pivotably supported about the swivel pin 6.

Further support positions 29a, 29b for further swivel pins 15 (see FIGS. 5 to 10; not shown in FIG. 12) are provided spaced from the swivel pins 6 in the support plates 28a, 28b and the ends of the tie rods 18a, 18b are pivotably supported thereon.

As can likewise be seen from FIG. 12, the guide rail 14 comprises an upper rail 14a and a lower rail 14b which are arranged over one another and which are each made in tubular form. The rails 14a, 14b have an annular cross-section. They are connected to one another by a middle piece 30. The middle piece 30 has an elongated rectangular cross-section whose central axis is disposed in the connection plane of the centers of the rails 14a, 14b. It is provided at its center with a connection part 31 which faces the interior of the vehicle and to whose end a panel 32 is fastened which has a substantially rectangular cross-section. The panel 32 covers the rails 14a, 14b with respect to the interior of the vehicle. Its upper end projects over the upper rail 14a.

The guide carriage 13 comprises an upper support sleeve 33a and a lower support sleeve 33b which extend over an angular range of approximately 270° in each case and in which the rails 14a, 14b are longitudinally displaceably guided. The open regions of the support sleeves 33a, 33b face one another. They leave room for the middle part 30 of the guide rail 14.

The support sleeves 33a, 33b are supported by corresponding projections 34a, 34b of the guide carriage 13 which face one another in a corresponding manner and have a cut-out extending over an angular range of approximately 90° to provide space for the middle part 30 of the guide rail 14. A cut-out 35 for the panel 32 is provided in the guide carriage 13 in addition to the projections 34a, 34b. Adjacent thereto, the guide carriage 13 has the support plates 28a, 28b.

Furthermore, a lock lever 36 is provided at the guide carriage 13 which is pivotably supported around the axis of the swivel pin 6 (in FIG. 12 the lock lever 36 has been omitted for reasons of a simplified drawing representation). The lock lever 36 has a guide groove 37 in the region of its end which is open to its end and which is substantially directed toward the pivot axis of the lock lever 36, that is, toward the swivel pin 6. A lock bolt 38 provided at the door 1 can engage into the guide groove 37.

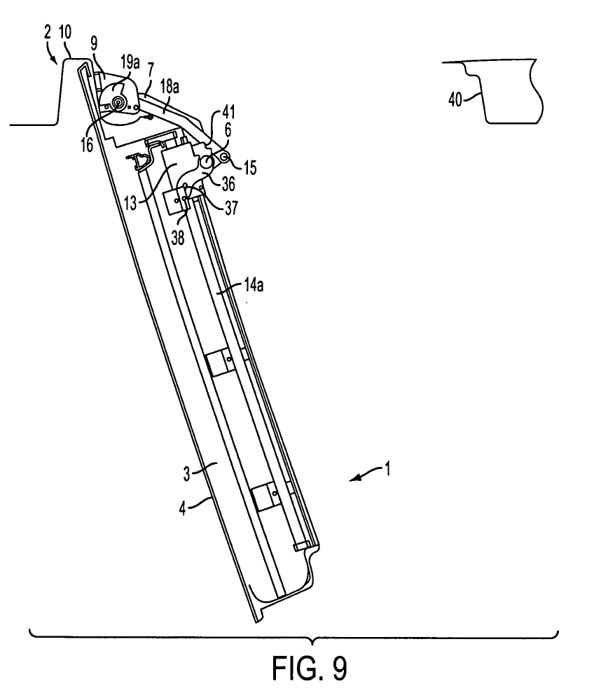

In FIG. 11, the basic position of the index bolts 20a, 20b, 24a, 24b is shown in which the first index bolts 20a, 20b rigidly connect the tie rods 18a, 18b to the articulated arm 7. In this position, the door 1 can be opened from the position shown in FIG. 5 by a rotary movement into the position shown in FIG. 9. As can be seen from FIG. 11, the first index bolts 20a, 20b engage through both the bearing bushings 21a, 21b of the articulated arm 7 and through the tie rods 18a, 18b. They end at a small distance in front of the hinges 9a, 9b. In this manner, the articulated arm 7 and the tie rods 18a, 18b are rigidly connected to one another, and indeed in the sense that the tie rods 18a, 18b are pivoted along in a compulsory manner on a pivoting of the articulated arm 7 about the support shaft 16.

The lock bolt 38 provided at the door 1 engages into the outer end of the guide groove 37 of the lock lever 36. In this manner, the lock bolt 38 locks the lock lever 36 and with it the guide carriage 13. The door can be opened like a conventional pivot door by a pivot movement about the support shaft 16 until the open position shown in FIG. 9 has been reached.

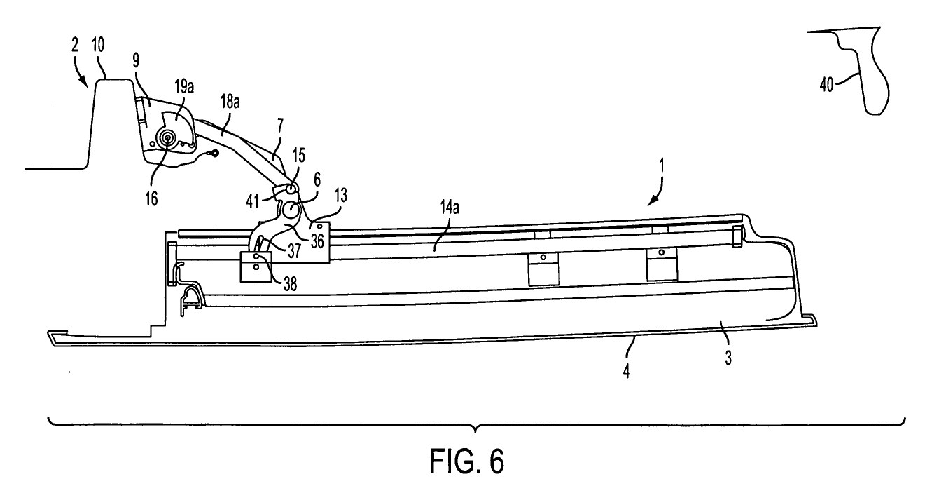

If the door 1 should be opened by a sliding movement, the rotary slide 19 is rotated about 90° clockwise until it has reached the position shown in FIGS. 6, 7 and 8. The index bolts 20a, 20b, 23a, 23b are hereby displaced toward the middle part 19c of the rotary slide 19 by the thickness of the tie rods 18a, 18b. The head of the upper first index bolt 20a runs downwardly on the upper slide curve 22a of the middle part 19c of the rotary slide 19 until it has reached the level of the line 39a. This movement of the upper first index bolt 20a is supported by the force of the compression spring 23a. In a corresponding manner, the lower first index bolt 20b is held in contact with the lower slide curve 22b by the force of the compression spring 23, said lower slide curve extending over the quarter-turn of the support shaft 16 at the level of the line 39b. The outer ends of the first index bolts 20a, 20b thus release the tie rods 18a, 18b.

The upper second index bolt 24a is pressed downwardly against the force of the compression spring 27a by the slide curve 26a at the lower side of the upper part 19a of the rotary slide 19 on the rotation of the rotary slide 19 until its lower end lies somewhat above the lower end face of the upper tie rod 18a. The lower second index bolt 24a is pressed upwardly in a corresponding manner against the force of the compression spring 27b by the slide curve 26b at the upper side of the lower part 19b of the rotary slide 19 on the rotation of the rotary slide 19 until its upper end lies somewhat below the upper end face of the lower tie rod 18b. In this manner, the second index bolts 24a, 24b establish a hinged connection between the tie rods 18a, 18b and the hinges 9a, 9b, that is a connection between the tie rods 18a, 18b and the vehicle.

The support shaft 16, the second index bolts 24a, 24b, the swivel pin 6 and the swivel pins 15 thus form a four-bar linkage in the support positions 29a, 29b of the guide carriage 13. When the articulated arm 7 is pivoted, the guide carriage 13 is taken along by the articulated arm 7 and thus pivoted about the support shaft 16. The guide carriage 13 is simultaneously pivoted in the opposite direction of rotation about the swivel pin 6 during this movement so that in the final analysis it is displaced in parallel by the action of the four-bar linkage.

Since the articulated arm 7 extends, starting from the support shaft 16, obliquely to the interior of the vehicle, on the rotation of the articulated arm 7 about the support shaft 16, the end of the door 1 facing away from the support shaft 16 would abut the oppositely disposed body part 40 so that the door 1 would be blocked and could not be opened any further. To prevent this, the guide groove 37 is present in the lock lever 36 and extends obliquely toward the swivel pin 6 and substantially arcuately about the support shaft 16. When the articulated arm 7 is pivoted, the guide groove 37 runs into the lock lever 38, whereby the lock lever 36 is pivoted in a clockwise direction around the swivel pin 6 with an increasing pivoting of the articulated arm 7. The guide carriage 13 is thereby moved in a direction away from the support shaft 16 relative to the door 1. Due to the associated relative movement of the door 1, it runs in a corresponding manner toward the support shaft 16 or away from the body part 40. The four-bar linkage, the lock lever 36, its guide groove 37 and the lock bolt 38 are matched to one another such that the door 1 is moved substantially at a right angle out of its opening in the body between the hinge 9 and the body part 40. The movement of the door 1 toward the body part 40 generated by the rotation of the articulated arm 7 per se is therefore substantially compensated by the described opposite movement of the guide carriage 13 until the door 1 has moved out of its opening and has adopted the position shown in FIG. 6.

In this position, the guide carriage 13 has moved in the guide 14 toward the body part 40. The lock lever 36 has been pivoted clockwise. The lock bolt 38 has run into the open guide groove 37 and out of this open guide groove 37 again. The lock lever 36 has an extension on its side facing away from the guide groove 37 and a recess 41 is provided therein which forms an abutment with the pin 15 in the support positions 29a, 29b.

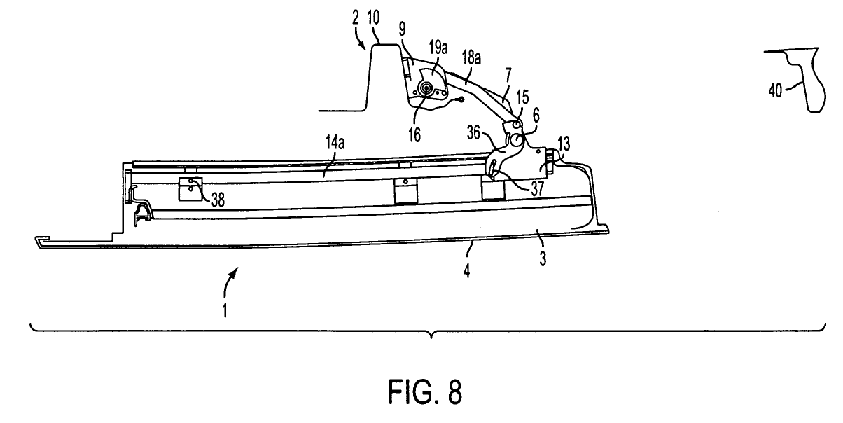

In the position shown in FIG. 6, the door 1 has been pivoted out so far that it does not abut the body on the subsequent parallel displacement into the position shown in FIG. 8.

On the closing movement of the door 1, it is first displaced in parallel from the position shown in FIG. 8 into the position of FIG. 6. In the position of FIG. 6, the lock bolt 38 engages into the guide groove 37 of the lock lever 36. The door 1 can now be closed by a pivoting of the articulated arm 7 and of the associated four-bar linkage.

The example pivoting/sliding doors provided herein have two opening functions, namely the opening function “slide” and the opening function “pivot”. Both functions can be carried out using one door hinge.

In the “pivot” function, the closed door is opened like a conventional pivot door with a pivot movement. In the “slide” function, the closed door is opened and closed with a linear movement in the sliding direction.

It is possible by the explained designs to open a vehicle door selectively as a pivoting door or as a sliding door. The unlocking or control can be made possible by an actuation at the outer side and/or at the inner side of the door, and indeed mechanically and/or electrically and/or by remote control. The guide for the sliding function is preferably located in the vehicle door. It is possible to design the guide rail in a replaceable manner. The guide rail can be made as a pressed section, a rolled section or as a hybrid part. The guide carriage can be guided at the top and/or bottom in the guide rail. The guide carriage can furthermore be guided in the section side in the guide rail. The components for the guide, that is the guide rail and/or the guide carriage, can be realized in steel, aluminum and/or plastic. The surface of the guide rail can be machined. It can in particular be lacquered, powdered, anodized or chromium plated. The guide rail can furthermore be covered by a panel. The panel can be realized in plastic, aluminum or steel. The surface of the panel can be lacquered, powdered, anodized or chromium plated.

As can be seen from FIG. 2, the door is rotated in the direction of rotation X in the hinge 9 so far out of the side wall of the vehicle 2 that the required freedom between the door box 3 and the side wall of the vehicle is ensured for the following linear movement.

1. A door for a vehicle, in particular for a motor vehicle, comprising a pivot joint at which an articulated arm hingedly connectable or connected to the vehicle is pivotably supported, wherein the pivot joint can be locked.

2. The door according to claim 1, wherein the pivot joint can be locked in a plurality of pivot positions.

3. The door according to claim 1, wherein the pivot range of the pivot joint is limited.

4. The door according to claim 1, wherein the pivot joint is provided at a guide carriage which is displaceably guided in a guide rail.

5. The door according to claim 4, wherein a tie rod is preferably hingedly connected to the guide carriage.

6. The door according to claim 5, wherein the tie rod is selectively connectable or connected to the articulated arm or hingedly to the vehicle.

7. The door according to claim 6, wherein a first index bolt can be brought into a position connecting the tie rod to the articulated arm.

8. The door according to claim 7, wherein a second index bolt can be brought into a position hingedly connecting the tie rod to the vehicle.

9. The door according to claim 8, wherein a rotary slide by which the first index bolt can be brought into the position connecting the tie rod to the articulated arm and/or the second index bolt can be brought into the position hingedly connecting the tie rod to the vehicle.

10. The door according to claim 4, wherein a lock lever is pivotably supported at the guide carriage.

11. The door according to claim 10, wherein the lock lever has a guide groove directed toward its pivot axis for a lock bolt provided at the door.

12. A vehicle including one or more doors in accordance with claim 1.

13. A door for a vehicle, comprising:
a pivot joint at which an articulated arm hingedly connectable or connected to the vehicle is pivotably supported, wherein the pivot joint is configured to be lockable, and wherein in a locked position, said joint is configured so that the door pivots and rotates outwardly at an increasing angle from the vehicle, and wherein in an un-locked position, said joint is configured so that the door slides with a linear movement along the vehicle.

14. The door of claim 13, wherein locking of said joint is mechanically controlled.

15. The door of claim 13, wherein locking of said joint is controlled from an inner side of the vehicle.

16. The door of claim 13, wherein locking of said joint is controlled from an outer side of the vehicle.

17. The door of claim 13, wherein locking of said joint is remote controlled.

18. The door of claim 13, wherein the pivot joint is provided at a guide carriage which is displaceably guided in a guide rail.

19. The door of claim 18, wherein the guide rail is covered by a panel.
